(19) United States
(12) Patent Application Publication
(10) Pub. No.: US 2013/0238503 A1
(43) Pub. Date: Sep. 12, 2013

(54) SYSTEM AND METHOD TO MANAGE INFORMATION FOR CONDUCTING SECURE TRANSACTIONS

(71) Applicant: Upen Patel, Vienna, VA (US)

(72) Inventor: Upen Patel, Vienna, VA (US)

(21) Appl. No.: 13/780,063

(22) Filed: Feb. 28, 2013

Related U.S. Application Data
(60) Provisional application No. 61/605,159, filed on Feb. 29, 2012.

(51) Int. Cl. G06Q 20/38

(52) U.S. Cl. CPC G06Q 20/385
USPC 705/44

(57) ABSTRACT

In a secure electronic transaction method, a unique code associated with a payer and payer's selected transaction method is generated, responsive to a request from the payer computing platform to conduct a transaction using that transaction method. A unique code received from a recipient is validated by attempting to match it with a stored unique code associated with a payer and payer's selected transaction method. Information received from the payer, recipient, and/or a transaction authorization network is stored in electronic storage. The unique code associated with the payer does not contain any transaction method information and is at least one of time-limited, one-time use, and limited to use with a single transaction partner.

This application claims the benefit of U.S. Provisional Patent Application No. 61/605,159, filed Feb. 29, 2012, which is hereby incorporated by reference in its entirety.

### TECHNICAL FIELD

This disclosure relates generally to electronic wallet systems and, more particularly, to a system and method to manage information for conducting secure transactions.

### BACKGROUND

Current implementations of digital wallets rely on a specialized smart phone, which contains a near field communication (NFC) chip to store payment instrument information. This puts an unnecessary burden on consumers to have to buy expensive equipment, as well as on the merchants to install registers that accept payment using NFC. If the consumer chooses not to buy a special smart phone with NFC, then they are disenfranchised of the benefits of a digital wallet. Use of NFC also limits consumer choice of phone providers, requiring that the user's NFC provider and phone provider have an agreement in place.

NFC chips store the electronic payment information on the smart phone. NFC chips can be hacked and if this smart phone is lost or stolen, then all the stored electronic payment information could be available to whoever stole or recovered the phone. Other payment solutions are also highly insecure. Cloud-based solutions use static 2D or QR codes to exchange information, and such codes are easily pirated, for example by taking a picture over a user's shoulder. The perpetrator can then use the picture to conduct fraudulent transactions.

As can be seen, there is a need for an improved digital wallet system for conducting secure transactions.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein. Embodiments disclosed herein provide systems and methods for conducting secure electronic transactions without the need for specialized equipment.

A new system for conducting secure electronic transactions includes one or more physical processors and storage media storing machine-readable instructions that cause the one or more physical processors to receive a transaction request comprising first transaction information from a first user, to store at least some of the first transaction information, to generate a system-generated code and associate the system-generated code with at least one of the stored transaction information and pre-existing first user information, to transmit the system-generated code to the first user, to receive a user-sent code from a second user with second transaction information, to validate the user-sent code and determine any stored transaction information and pre-existing first user information associated with the user-sent code, to cause an authorization decision to be rendered for a transaction associated with the stored transaction information and pre-existing first user information associated with the user-sent code and second transaction information, and to transmit the authorization decision to at least one of the first user and the second user. The system-generated code does not contain any transaction method information and is at least one of time-limited, one-time use, and limited to use with a single transaction partner.

In embodiments, the system-generated code may expire after fifteen minutes or less. The machine-readable instructions may further cause the one or more physical processors to create a transaction-level code associated with the system-generated code that is at least one of audible and visual. The transaction-level code may be a barcode or QR code. In other embodiments, the transaction-level code may be any other machine-readable code, for example it may be alphanumeric, and may be audible in part or in full, and received with e.g. a recipient's microphone. Causing an authorization decision to be rendered for the transaction may involve submitting the transaction to an authorization network for a payment method associated with the transaction, and the machine-readable instructions may further cause the one or more physical processors to receive the authorization decision from the authorization network. There may be a payment account associated with the first user or the second user, and causing an authorization decision to be rendered for the transaction may involve rendering the authorization decision based on information associated with the transaction and with the payment account.

The first user may be a payer and the second user may be a recipient. The first transaction information from the payer may include identification of the payer and a desired transaction method and the pre-existing first user information may include details associated with the desired transaction method, and the second transaction information may include identification of the recipient. The identification of the payer and recipient may be any information that allows for data corresponding to the payer or recipient, respectively, to be looked up. For example, a user may create a user ID on registration, which may be associated with the user's information, and the user ID may be the identification. Or, the identification may be the user's smart phone serial number, etc.

The desired transaction method may include a desired payment method and the details associated with the desired transaction method may include identifying information for the desired payment method. The identifying information may be, for example, a credit card number, expiration date, card security code, and/or billing information, or a login and password for an online payment service.

The first user may be a recipient and the second user may be a payer. The first transaction information from the recipient may include identification of the recipient, the second transaction information may include identification of the payer and a desired transaction method, and the machine-readable instructions may further cause the one or more physical processors to use the identification of the payer to retrieve pre-existing payer information including details associated with the desired transaction method. The desired transaction method may include a desired payment method and the details associated with the desired transaction method may include identifying information for the desired payment method.

The user-sent code may be the transaction-level code, and validating the user-sent code may involve translating the user-sent code to the system-generated code. The machine-readable instructions may further cause the one or more physical processors to determine whether the first user is located proximate the second user, and to require additional authentication steps if the first and second users are determined not to be proximate one another.

The machine-readable instructions may further cause the one or more physical processors to display a graphic interface to the first user for inputting the first transaction information, and to create, and at least one of display and broadcast, a transaction-level code associated with the system-generated code that is at least one of audible and visual. The machine-readable instructions may further cause the one or more physical processors to display a graphic interface for receiving the second transaction information from the second user, to at least one of scan and image the transaction-level code and translate it to the system-generated code, and responsive to a successful authorization decision, to display a graphic interface for signing and to receive the first or second user's signature.

The machine-readable instructions may further cause the one or more physical processors to display a graphic interface for receiving the second transaction information from the second user, at least one of scan and image a transaction-level code and translate it to the user-sent code, and responsive to a successful authorization decision, to display a graphic interface for signing and to receive the first or second user's signature.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flow chart showing steps for a payer to prepare to make a payment according to an exemplary embodiment of the present invention;

FIG. 2 is a flow chart showing steps for a recipient to receive payment when the system manages the task of gaining authorization from the network according to an exemplary embodiment of the present invention;

FIG. 3 is a flow chart showing steps for a recipient to receive payment when the recipient system manages the task of gaining authorization from the network, according to an exemplary embodiment of the present invention;

FIG. 4 illustrates a system configured to facilitate a payment from a payer to a payee using a digital wallet, according to an exemplary embodiment of the present invention;

FIG. 5 is a flow chart showing steps for a recipient to prepare to receive a payment according to an exemplary embodiment of the present invention;

FIG. 6 is a flow chart showing steps for a payer to make payment when the system manages the task of gaining authorization from the network according to an exemplary embodiment of the present invention;

FIG. 7 is a screenshot of a digital wallet app payment selection and initiation screen, according to an exemplary embodiment of the present invention;

FIG. 8 is a screenshot of a digital wallet app payment selection and initiation screen, according to an exemplary embodiment of the present invention;

FIG. 9 is a screenshot of a digital wallet app recipient payment code scanner screen, according to an exemplary embodiment of the present invention;

FIG. 10 is a screenshot of a digital wallet app recipient payment amount entry screen, according to an exemplary embodiment of the present invention;

FIG. 11 is a screenshot of a digital wallet app recipient payment amount entry screen, according to an exemplary embodiment of the present invention;

FIG. 12 is a screenshot of a digital wallet app recipient payment approval screen, according to an exemplary embodiment of the present invention;

FIG. 13 is a screenshot of a digital wallet app payment code display screen, according to an exemplary embodiment of the present invention;

FIG. 14 is a screenshot of a digital wallet app recipient ID verification screen, according to an exemplary embodiment of the present invention;

FIG. 15 is a screenshot of a digital wallet app transaction confirmation screen, according to an exemplary embodiment of the present invention;

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python, Ruby on Rails, assembly language or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

Embodiments as disclosed below relate to systems and methods for conducting secure electronic transactions without the need for specialized equipment.

Broadly, an embodiment of the present invention provides an alternative for a consumer to gain the benefits of a digital wallet using any smart device, without the need for NFC capability. Embodiments of the present invention utilize an application-based approach, which can support any smart device using that device-specific operating system.

An application on a client computing device such as a smart phone can securely receive in encrypted form, over a network, electronic payment information stored on a system server. Electronic payment information may include any information relating to electronic payment methods, such as credit and debit cards, prepaid cards, gift cards, stored value cards, integration to bank account, ACH/electronic check, PayPal® Google Wallet, etc., for example credit card numbers, expiration dates, and billing information, bank account and routing numbers for electronic check payments, PayPal® login information for PayPal® payments, etc. The electronic payment information is never sent back to the consumer's smart device application. Instead, a unique code which represents an electronic payment method stored on the system server is generated from the system server and sent to the payer. That code is validated by the system server, when submitted by a recipient in relation to a payment transaction. The code recipient is the entity receiving the payment, and may for example be a retailer.

This unique code may be valid for a set time, such as one minute or three minutes, within which it needs to be submitted to the system server for validation in relation to a payment transaction, for a single transaction, and/or only for a single merchant. For example, for a standard transaction with a payer-generated code, that code may be single-use, such that once the code is received at the system server from a recipient it is deactivated and cannot be used again. The code may contain universal date/time and geographic information embedded in it, along with other live and static variables, making the chances of ever reusing the same code infinitely small. That code may also be time-limited to expire automatically if not submitted to the system server within a set time frame, such as 15 minutes. The time limit should be set low enough to make it difficult for someone to capture the code, find a desired item to purchase, and checkout before the time limit runs out, but high enough not to expire often for normal transactions. In some embodiments, the time limit may be user configurable, and/or may vary depending on the recipient or type of transaction. For example, a high value transaction may take longer to finalize, so the time limit might be set higher for such a transaction. For a recurring payment, the code may be limited to a single recipient, but allowed to persist for an extended time and repeated transactions. A recurring code may still be limited to a certain period of time without reauthorization from the payer. Recipient-generated codes may be time-limited and one-time use as for payer-generated codes, and may additionally be limited to use with the generating recipient.

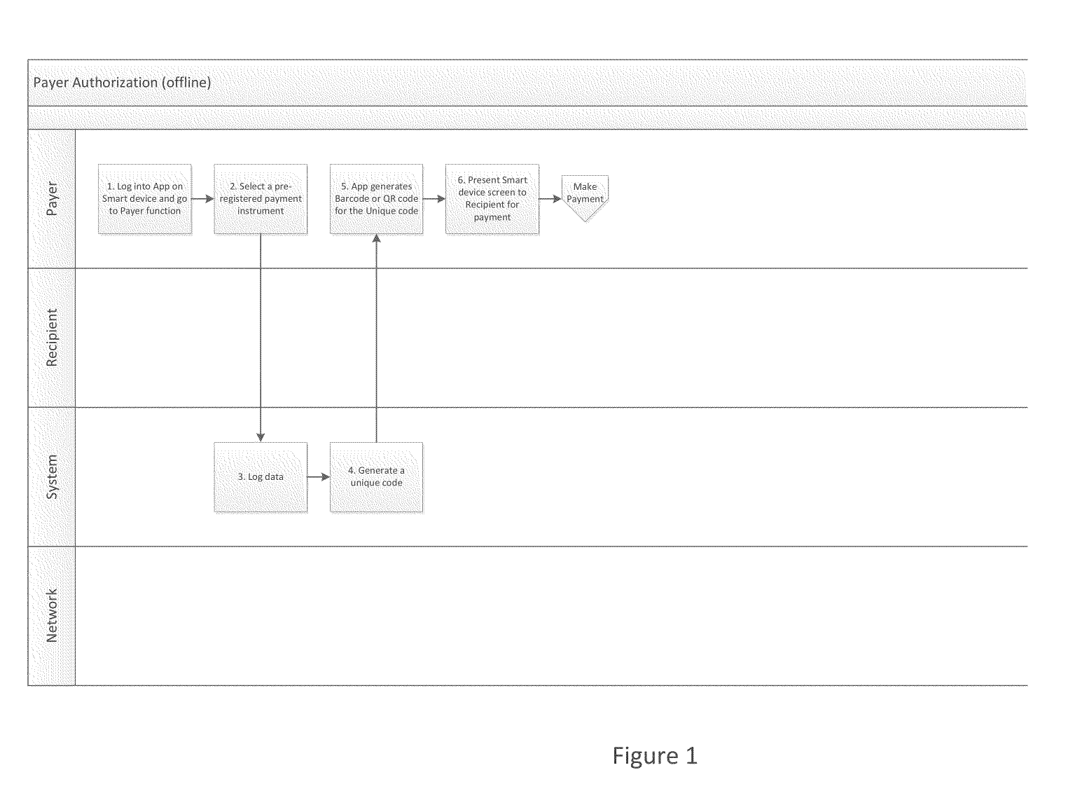

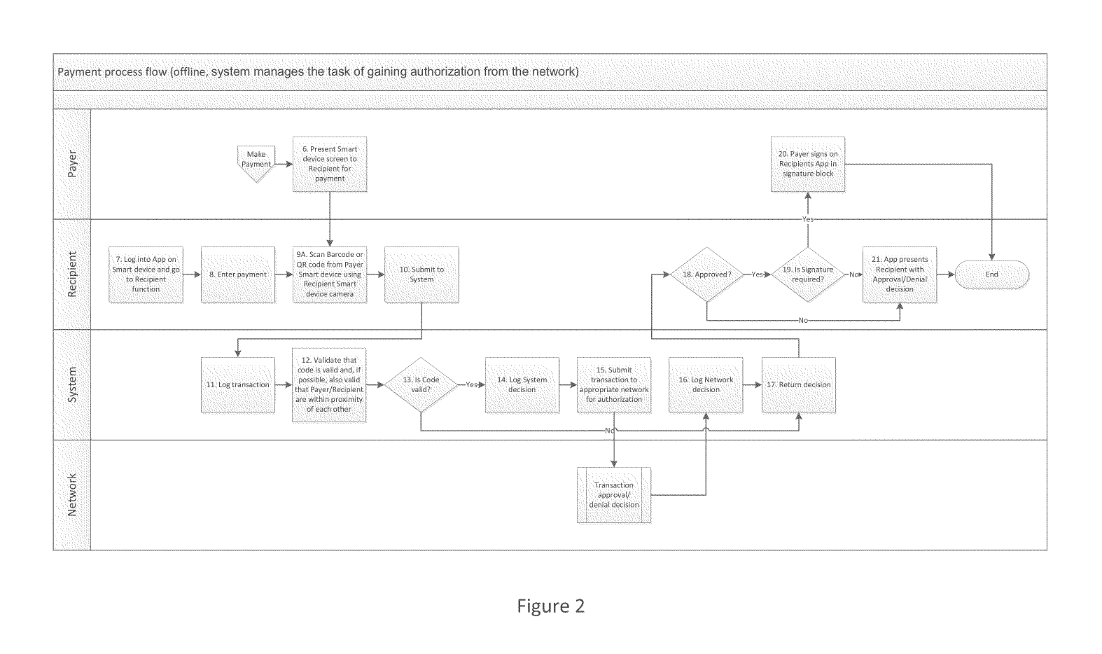

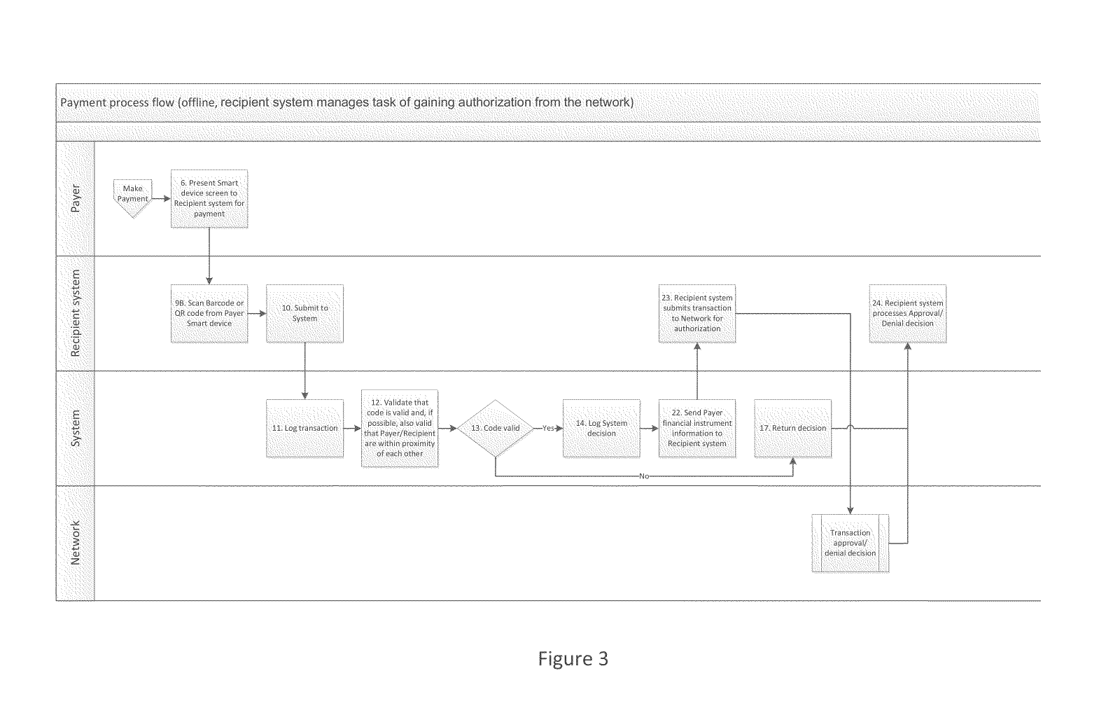

In some embodiments, there may be multiple code time limits during a transaction. For example, a generated code may expire in one minute if it is not scanned by a recipient within that time. The payer's app may detect whether the code has been scanned, and transmit a signal to the system server to deactivate the code after the time limit if it has not. Then after scanning, a second time-limit may begin. For example, there may be a five minute time limit between scanning the code and sending the code to the system server to complete the transaction. The recipient app may be configured to send a deactivation signal to the system server after the time limit if the code has not been submitted for transaction completion by that time. Various such time limits may be used in various embodiments, for example there may be a time limit between any two steps in a transaction, as when using an ATM. Referring now to FIGS. 1 through 3, payer authorization (steps 1-6), FIG. 1, takes place in all three instances. If the recipient relies on the system server to process payment transactions, then steps 7, 8, 9A, and 10-21, shown in FIG. 2, may additionally take place. If the recipient does not use the system server to process payment transactions, then steps 9B, 10-14, 17, and 22-24, FIG. 3, may additionally take place. These steps are described in greater detail in the accompanying drawings.

The system server can be enhanced to store other verified information (such as, but not limited to, identity documents, medical or other insurance information, boarding passes, transit passes, library card, membership/club cards, etc.), which can be presented to a requestor, via a unique code or as a digital copy of the information, in place of the original. In the case of a unique code, the requestor can retrieve a verified copy of the information from the system server, by presenting the code to the system server. Thus, embodiments of the invention are not limited to payment transactions, but rather may encompass any type of information transfer that can be carried out electronically (which includes information that can be relayed visually or through audio through computing device outputs).

In embodiments, unique codes may be enhanced so that they are not a one-time use code. In such cases, the system server may issue a code unique to a given recipient which the recipient may store and re-use as needed, for example after authenticating a payer with login information. The code may also be used for recurring billing, for example where a customer is billed each month for a subscription without the customer having to re-authorize the payment each time. In recurring billing scenarios, the recipient may indicate that a transaction involves recurring billing, for example by checking a box on a payment processing screen of a smart phone app, and submits that to the server with other transaction information. The server may then display to the payer, via the payer's app, the details of the recurring transaction (recipient, recurring amount, and/or time between charges, etc.) and prompt the payer for approval. The payer may approve by entering a payment security code. The payment security code may be set in the app in advance by the payer, and may be a dedicated code used only for transaction approval, or may also be used for logging into the app and/or accessing various other functions of the app. This password may be in any known password/authentication form, e.g. alphanumeric, drawn pattern, voice, picture selection, etc.

This simplifies the transaction for the recipient, while maintaining the security of the payer's electronic payment information. The payer, via the payer's app, may have the ability to manage recurring payments, e.g. set payment date, set end date, change amount, cancel, etc. The recipient in some embodiments may also have the ability through the recipient's app to manage recurring payments, for example canceling or delaying charges for items that are out of stock.

In embodiments, the recipient receives the code from the payer by taking an image of the payer's computing device display with a web camera connected to a recipient computing device while the payer displays the unique code on the display of the payer's computing device. This code transmission method necessarily requires a transaction where the recipient computing device is proximate the payer's computing device.

For online transactions, the web camera may be connected to a second payer computing device (e.g. desktop of laptop), and the recipient may control the payer's web camera using software run by the payer to take the image of the code displayed on the payer's other computing device (e.g. smart phone) and transmit it to the recipient. In other online embodiments, the unique code may appear on the payer's computing device (e.g. smart phone) or payer's second computing device (e.g. desktop, laptop) and be captured with a screen shot taken by the payer, for example using software provided by the recipient that automatically transmits the screen shot to the recipient and/or filters out other images besides the code that are displayed on the payer's computing device.

In other online or off-line embodiments, the payer may have an image (e.g. jpeg) or other file of the unique code, which may be received directly from the system server via the app. Alternatively, the file may be created by one of the payer's computing devices using a connected web camera (e.g. taking a picture of the payer's mobile phone displaying the code with the payer's desktop computer and connected webcam), screen shot, or the like. The payer may edit the image as necessary to crop out other information besides the code, etc., and then transmit it directly to the recipient. Where the payer receives the file directly from the system server, the file may be automatically forwarded on to the recipient without further action on the part of the payer.

FIG. 1 depicts an embodiment of a method for making a payment to a recipient using a digital wallet. One skilled in the art will appreciate that the following method is presented as an exemplary non-limiting embodiment, where in other embodiments steps may be performed in various orders, combined, omitted, and/or additional steps may be included.

In this embodiment, a payer who wishes to make a payment takes the step 1 of logging into an app on the payer's smart device and selecting a payer function. Smart devices may include smart phones, tablets, PDAs, and other mobile computing devices. In other embodiments, any type of computing device may be substituted for a smart device, including a home desktop, laptop, terminal or kiosk, etc. The payer has previously set up the application and registered information relating to one or more of the payer's electronic payment methods with the app. For example, the payer may have entered the credit card number, expiration date, CSC code, and billing information for various credit and/or debit cards, login information for various online payment methods, etc. The payer next takes the step 2 of selecting a pre-registered payment method from those registered with the app, which the payer wishes to use to make payment. The payer's selection is transmitted by the app to the system server, which takes the step 3 of receiving and logging the incoming selection from the payer. Logging may entail, for example, creating a transaction entry in a database or other electronic storage and storing data (e.g. the selection) in association with that entry. Future logged information may be stored in association with an existing entry and associated information. The system server then undertakes a step 4 to generate a unique code corresponding to the payment method selected and transmits the code back to the payer's smart device via the app. At step 5, the app generates a 2D or 3D barcode or QR code, which in other embodiments may be any other machine-readable code presentation format, corresponding to the unique code and displays the barcode or QR code on the smart device's screen. In alternative embodiments, any type of code may be generated by the app for use by the payment recipient, for example an alphanumeric string, an audio signal, etc. At step 6, the payer presents the screen showing the barcode or QR code to the payment recipient, who uses that barcode or QR code to process the payer's payment as illustrated in FIGS. 2 and 3.

FIG. 2 depicts an embodiment of a method for processing a payment from a payer using a barcode or QR code generated by the payer's app. The recipient may be any entity the payer wishes to make a one-time or recurring payment to. In other embodiments, the recipient may be any entity the payer wishes to transmit information to, such as an airline, library, etc. In this embodiment, the recipient in step 7 logs into an app on the recipient's smart device and selects a recipient function. In this embodiment, the app allows any user to act as a payer or recipient by selecting the appropriate function from within the app, if the user has set up the app appropriately. In other embodiments, there may be separate apps for payers and for recipients, since many users may act primarily as either payer or recipient, but not both. In other embodiments, any computing device may be substituted for the smart device, as described for the payer above. For embodiments with kiosks or terminals, payer and recipient may use the same kiosk or terminal.

The recipient scans 9 the barcode or QR code (or other code, in other embodiments) provided by the recipient using a camera on the recipient's smart device. In step 8, the recipient enters purchase information relating to the purchase the payer wishes to make into the app. For example, the recipient might enter the total dollar amount of the purchase and a description of the purchase. Although step 9 is illustrated as occurring after step 8 in FIG. 2, this order is arbitrary and scanning the code could come before entering purchase information, or vice versa. The app may permit either order. The scanning functionality may be provided by the app. In other embodiments, the scanning may be performed using a microphone on the smart device, or using a dedicated barcode scanner, web camera or the like connected to or integrated into recipients computing device. The recipient then transmits 10 the scanned QR code or barcode to the system server with the purchase information via the app or API integration. The system server receives the transmitted QR code or barcode and purchase information and logs the transaction 11, then validates 12 the unique code contained in the QR code or barcode. At the time the unique code was generated in step 4 (FIG. 1), the system server may have associated the generated unique code with the payer and the payer's selected payment method, for example in a database. Thus, in step 12 the server system matches the received unique code to a unique code stored in association with a payer and payer payment method.

At step 12, the system server may also determine whether the payer and recipient are proximate one another. This may be done, for example, by the app collecting GPS information from the payer smart device at the time the payment method selection is made and sending it with the payment method selection to the system server (step 2). The system server may then store the GPS location information in step 3 and associate it with the unique code. The app may also collect GPS information from the recipient's smart device in steps 7-9 and transmit that information to the system server along with the scanned barcode or QR code in step 10, at which point the recipient GPS location information can be stored in step 11 and compared in step 12 with the location information associated with a payer matching the scanned QR code or barcode. This location validation helps to identify fraud or a compromised system when the app is used for face-to-face retail-type transactions.

If a retail-type transaction is indicated but the payer and recipient are found to be far apart, the barcode or QR code may have been intercepted in some manner and transmitted to a different recipient than the one intended. In on-line transactions, the system server may check the payer's location against verified payer locations, for example by using IP address geographic information and/or GPS information to obtain current geographic information and comparing that to geographic information obtained during previous transactions and/or registration. If the current geographic information does not match a verified payer location, the app may prompt the payer to verify the transaction, for example by entering the payer's payment security code.

If the unique code validation determines 13 that the unique code is valid, this determination is logged 14, and the electronic payment information associated with the unique code, together with the purchase information, is transmitted 15 by the system server to an appropriate Network for transaction authorization if needed. In some embodiments, the system server may host its own managed prepaid account that payers may use to conduct transactions. When using a self-hosted payment account, there is no separate network to obtain authorization from, so step 15 may alternatively entail the system server making its own transaction approval/denial decision. The system server then receives and logs the Network approval or denial of the transaction 16 and returns the approval or denial decision 17 to the recipient via the recipient's app. If the unique code validation determines 13 that the unique code is invalid, for example because no matching payer is found or because the payer is not proximate the recipient, the system server returns the invalidity decision 17 to the recipient via the recipient's app. If the recipient determines 18 that the transaction has been approved, an additional determination 19 is made as to whether a signature is required by the Network payment authorization entity. This information may be relayed with the validation/authorization information by the system server to the recipient. If a signature is required, the app displays a signature block on the recipient's smart device and the payer signs in the signature block 20, which is captured by the app and may be stored locally or transmitted to the system server for storage. If no signature is required, the app displays to the recipient the transaction approval decision. If the transaction was denied, the app displays to the recipient the transaction denial decision.

In embodiments in which the system server is given the responsibility for managing the task of gaining payment authorization from the network (as for example illustrated in FIG. 2), the first test during the transaction occurs when a code is presented to the system server. If the code is determined by the system server to be valid, then further processing takes place. If the code is determined to be not valid, then processing stops and a denial decision is returned by the system server to the recipient. If the code is valid, then the electronic payment information corresponding to the code is sent by the system server to the Network for authorization (or in the case of self-hosted payment accounts, the system server makes its own authorization decision as addressed above). The Network may be any third-party payment authorization entity. For example, for a payment by credit card the Network may be a credit card payment processor network, for a payment by PayPal® the Network may be PayPal® servers, etc.

FIG. 3 depicts an embodiment of a method for processing a payment from a payer using a barcode or QR code generated by the payer's app. In this embodiment, the recipient requests authorization of a transaction from a Network payment authorization entity directly. The steps in FIG. 3 are identical to those in FIG. 2 through step 14. However, after code validation 12, instead of the system server sending electronic payment information associated with the unique code, together with the purchase information, directly to an appropriate Network for transaction authorization, that information is sent 22 back to the recipient via the app. The recipient then transmits 23 that information to an appropriate Network for transaction authorization. In this embodiment, the recipient need not transmit purchase information to the system server at step 10, in which case only the electronic payment information is returned by the system server to the recipient and not also purchase information. The Network's transaction approval or denial decision is then transmitted directly to the recipient server via the app, which receives and processes the decision 24. In some embodiments, the process of submitting the payment information received from the system server for authorization need not be performed directly through the app, but rather can be performed by standard payment processing software after receipt of the payment information from the app or even directly from the system server.

Where the recipient manages the task of gaining authorization from the Network, as illustrated in the embodiment of FIG. 3, the first test during the transaction occurs when a code is presented to the system server. If the code is valid, then further processing takes place. If the code is not valid, then processing stops and a denial decision is returned by the system server to the recipient. If the code is valid, then the payer's electronic payment information is sent by the system server to the recipient for further processing.

FIG. 4 illustrates a system configured to facilitate a payment from a payer to a payee using a digital wallet, according to an exemplary embodiment of the present invention. In some embodiments, system 100 may include one or more system servers 102. The system server(s) 102 may be configured to communicate with a payer computing platform 104 according to a client/server architecture. The users may access system 100 via payer computing platform 104, for instance, to initiate a payment using a digital wallet.

The system server(s) 102 may be configured to execute one or more computer program modules. The computer program modules may include one or more of a code generation module 106, a code validation module 108, interface module 110, logging module 112, network authorization module 114, and/or other modules. As noted, the payer computing platform 104 may include one or more computer program modules to facilitate transaction processing.

The code generation module 106 may be configured to generate a unique code associated with a payer's selected method of payment in response to a request from payer computing platform 104 to make a payment using that method of payment. While the code may be associated with the payer and the payer's selected method of payment, the code itself may contain no payment method information, for maximum security. Rather, the code may be used to look up payment method information stored in electronic storage, etc. The code generation module 106 may alternatively or additionally be configured to generate a unique code associated with a recipient and a purchase in response to a request from recipient computing platform 116 to receive a payment for that purchase. The payer can scan the recipient-generated code to complete the transaction. For example, a payer may go to a retail store and select the secure transaction system for checkout. A unique code is generated by the recipient, and presented on the screen of a recipient computing device, which the payer scans using the payer's app on the payer's computing device. The amount of the purchase is determined form the code and automatically filled in on the payer's screen. The payer presses “pay”, and is communicated to the system server. The system server then credits the recipient for the purchase and informs the recipient computing device via API integration that the payment has been received, and the transaction is completed.

The code validation module 108 may be configured to validate a unique code received from the recipient computing platform 116. It may first transform a received barcode or QR code into the unique code it represents, or in embodiments this transformation may be performed through an app on the payer computing platform 104. Code validation module 108 may be configured to validate the unique code by attempting to match it with a unique code stored in electronic storage 118 and associated with a payer and payer payment method. The code validation module 108 may also be configured to determine whether the payer computing platform and recipient computing platform are proximate one another and/or whether the payer computing platform is proximate a verified payer location. It may be configured to make this proximity determination, for example, by receiving GPS or IP address geographic information from the payer computing platform 104 and (if comparing the two locations) from recipient computing platform 116 and comparing the two.

Interface module 110 may be configured to allow system server(s) 102 to communicate with other elements, e.g., the payer computing platform 104, recipient computing platform 116, and/or transaction authorization server(s) 124, via network 122. Interface module 110 can use one or more wireless transceivers for performing wireless communication and/or one or more communication ports for performing wired communication.

Logging module 112 may be configured to log in electronic storage 118 information received from the payer computing platform 104, recipient computing platform 116, and/or transaction authorization network 124, as well as steps taken at the system server(s) 102 and determinations and decisions made by the system server(s) 102 and/or transaction authorization network server(s) 124.

Network authorization module 114 may be configured to submit electronic payment information associated with a unique code, together with the purchase information to the appropriate transaction authorization network server(s) 124 for transaction authorization and to receive and process the approval or denial decision from the transaction authorization network server(s) 124 and relay that decision to the recipient computing platform. In other embodiments, network authorization module 114 may not be needed, as authorization requests to the transaction authorization network server(s) 124 may be handled directly by the recipient computing platform 116, or authorization requests to an outside network may be unnecessary, as in the case where the payment method is hosted on the system server.

A given payer computing platform 104 may include one or more processors configured to execute computer program modules. The computer program modules may be configured to enable an expert or user associated with the given payer computing platform 104 to interface with system 100, recipient computing platform 116, and/or transaction authorization network server(s) 124, and/or provide other functionality attributed herein to payer computing platform 104. For example, the computer program modules may be configured to allow a user to choose between payer and recipient functions and to generate and display a 2D or 3D barcode or QR code (or in embodiments, any machine-readable code presentation format) for a unique code received from the system server(s) 102. By way of non-limiting example, the given payer computing platform 104 may include one or more of a desktop computer, a laptop computer, a handheld computer, a netbook, a smartphone, mobile phone, a kiosk or terminal, and/or other computing platforms.

A given recipient computing platform 116 may include one or more processors configured to execute computer program modules. The computer program modules may be configured to enable an expert or user associated with the given recipient computing platform 116 to interface with system 100, payer computing platform 104, and/or transaction authorization network server(s) 124, and/or provide other functionality attributed herein to recipient computing platform 116. For example, the computer program modules may be configured to receive purchase information from a recipient, to scan a barcode or QR code displayed on the payer computing platform 104, to transmit purchase information and/or barcode or QR code (or underlying unique code) information to the system server(s) 102, to receive approval or denial decision information from network authorization network server(s) 124 directly or through system server(s) 102 and display the information, to determine if a signature is required and to display a signature block for a payer to sign and capture a signature entered by the payer, and/or to transmit purchase and electronic payment information to network authorization network server(s) 124 for transaction authorization. By way of non-limiting example, the given recipient computing platform 116 may include one or more of a desktop computer, a laptop computer, a handheld computer, a netbook, a smartphone, a kiosk or terminal, and/or other computing platforms.

The transaction authorization network servers 124 may be associated with any third-party payment authorization entity. For example, for a payment by credit card the Network may be a credit card payment processor network, for a payment by PayPal® the Network may be PayPal® servers, etc.

The server(s) 102 may include electronic storage 118, one or more processor(s) 120, and/or other components and may be a high availability and/or disaster recovery-enabled system. The server(s) 102 may include communication lines or ports to enable the exchange of information with a network 122 and/or other computing platforms. The illustration of server(s) 102 in FIG. 1 is not intended to be limiting. The server(s) 102 may include a plurality of hardware, software, and/or firmware components operating together to provide the functionality attributed herein to server(s) 102. For example, server(s) 102 may be implemented by a cloud of computing platforms operating together as server(s) 102. The above comments apply equally to transaction authorization network server(s) 124.

Electronic storage 118 may comprise non-transitory storage media that electronically stores information. The electronic storage media of electronic storage 118 may include one or both of a system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from payer computing platform 104 and/or recipient computing platform 116, and/or other information that enables server(s) 102 to function as described herein.

Processor(s) 120 is configured to provide information processing capabilities in system server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. The processor(s) 120 may be configured to execute modules 106, 108, 110, 112, 114 and/or other modules. The processor(s) 120 may be configured to execute modules 106, 108, 110, 112, 114, and/or other modules by software; hardware; firmware; some combination of software, hardware, and/or firmware; and/or other mechanisms for configuring processing capabilities on processor(s) 120. As noted, in certain implementations, a given payer computing platform 104 may include one or more computer program modules. The given payer computing platform 104 may include one or more processors that are the same or similar to processor(s) 120 of the server(s) 102 to execute such computer program modules of the given payer computing platform 104. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 106, 108, 110, 112, 114 are illustrated in FIG. 1 as being co-located within a single processing unit, in implementations in which processor(s) 120 includes multiple processing units, one or more of modules 106, 108, 110, 112, 114 may be located remotely from the other modules. The description of the functionality provided by the different modules 106, 108, 110, 112, 114 described below is for illustrative purposes, and is not intended to be limiting, as any of modules 106, 108, 110, 112, 114 may provide more or less functionality than is described. For example, one or more of modules 106, 108, 110, 112, 114 may be eliminated, and some or all of its functionality may be provided by other ones of modules 106, 108, 110, 112, 114. As another example, processor(s) 120 may be configured to execute one or more additional modules that may perform some or all of the functionality attributed below to one of modules 106, 108, 110, 112, 114.

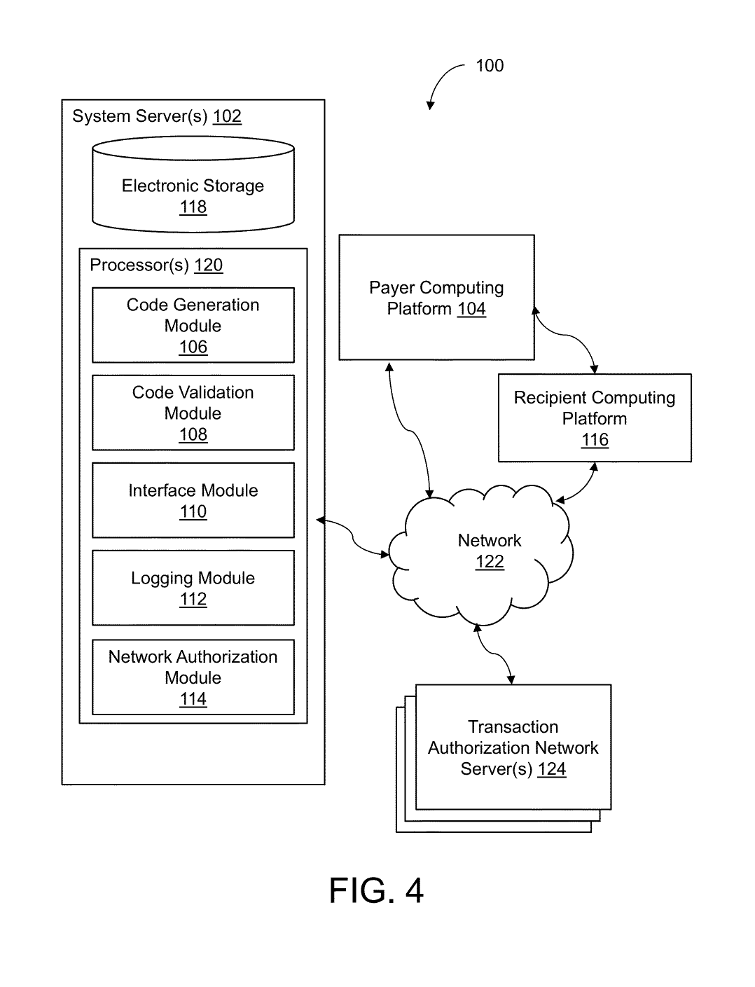

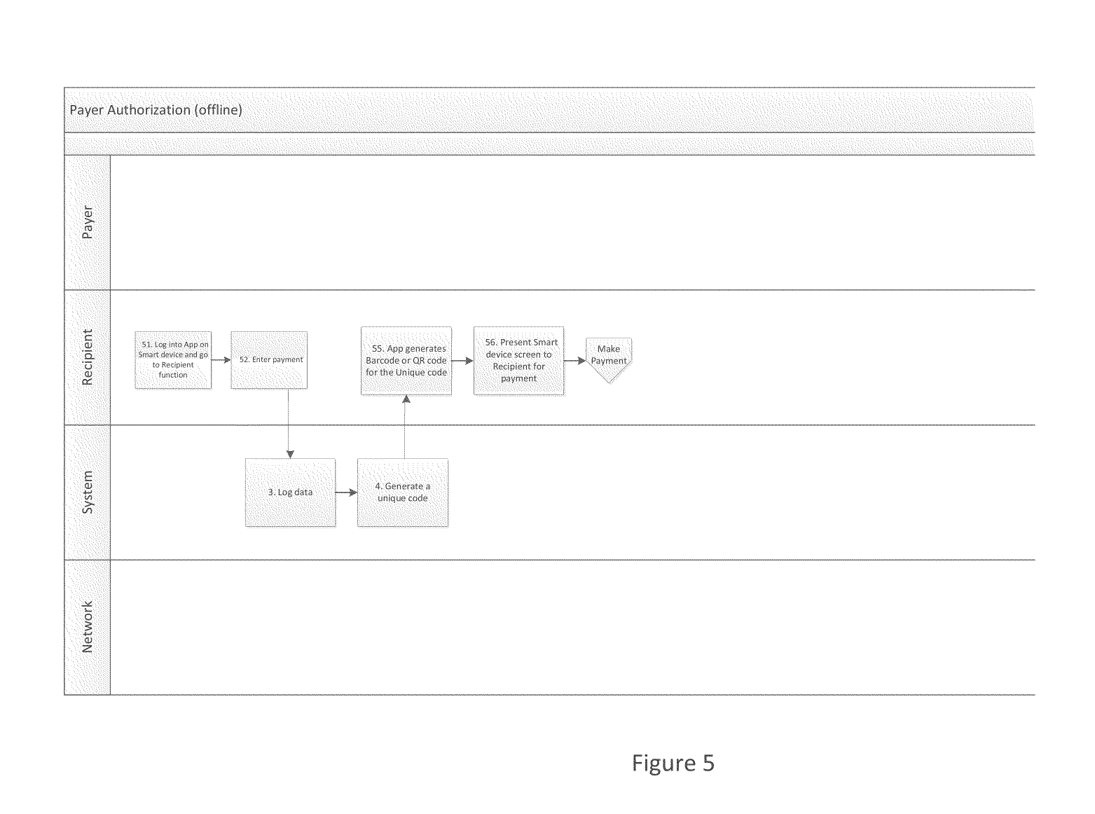

FIG. 5 is a flow chart showing steps for a recipient to prepare to receive a payment according to an exemplary embodiment of the present invention. This flow chart is similar to that shown in FIG. 1, except that here the recipient initiates the payment transaction by entering the payment amount 52 and optionally other information after logging into the app and selecting a recipient function 51, and transmits the information to the system server to cause generation of the unique code 4. The recipient then generates the barcode or QR code 55 and displays it to the payer 56.

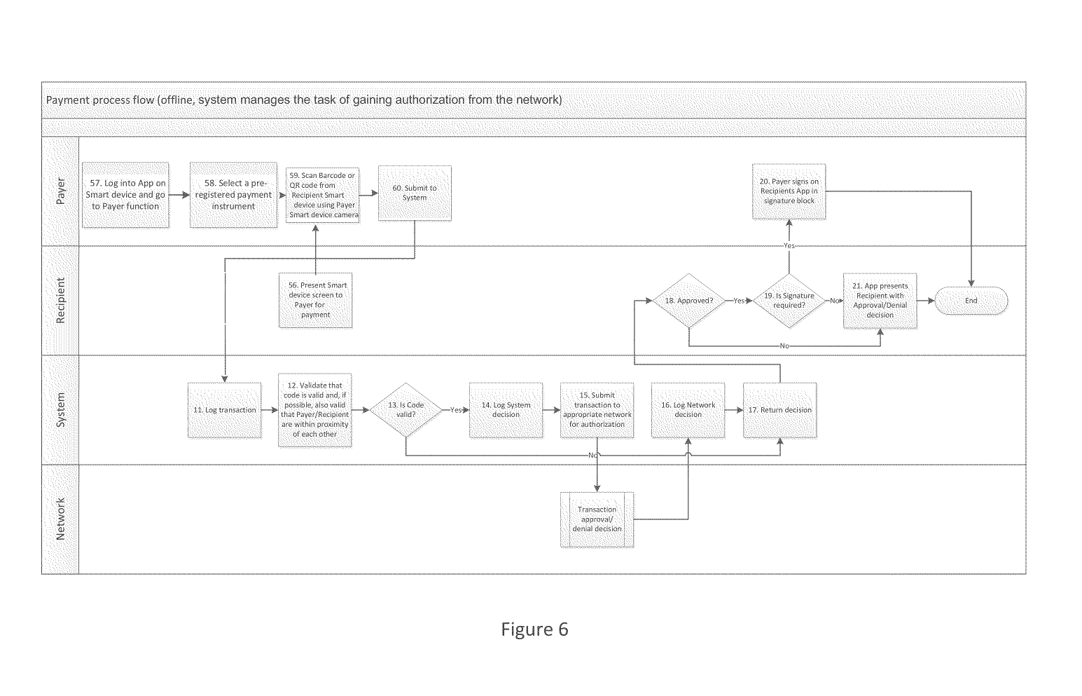

FIG. 6 is a flow chart showing steps for a payer to make payment when the system manages the task of gaining authorization from the network according to an exemplary embodiment of the present invention. This flow chart is similar to that shown in FIG. 2, except that here it is the payer who scans the barcode or QR code 59 and submits the scanned code to the system server 60 after logging into the app and selecting the payer function 57 and selecting a pre-registered payment instrument 58 (in various embodiments, the payment instrument may be selected before or after scanning the code).

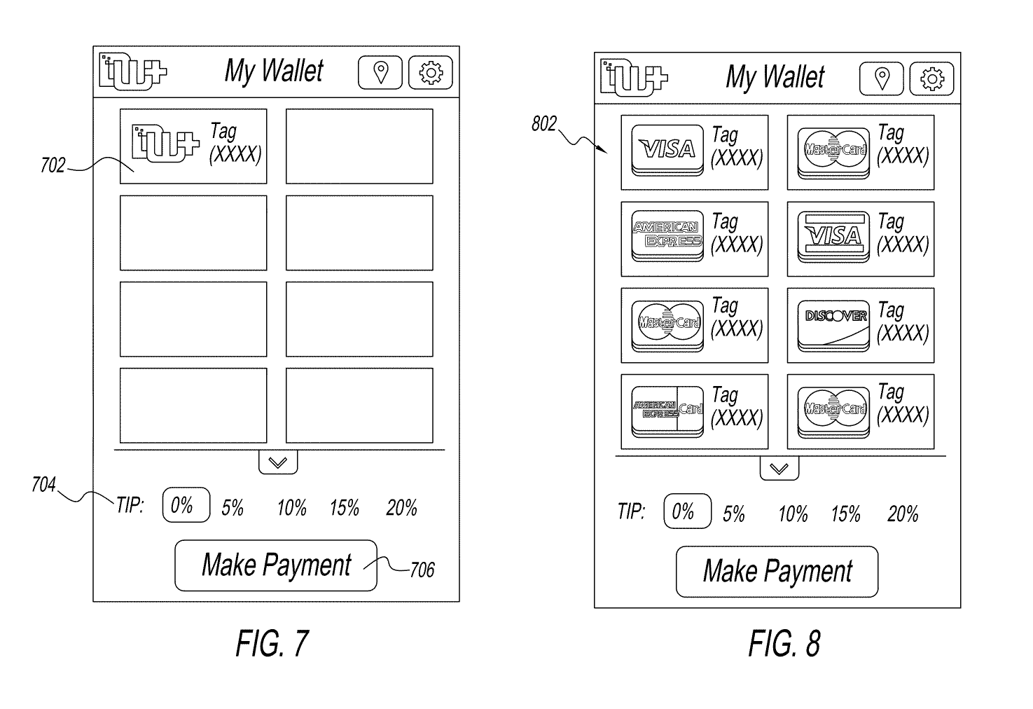

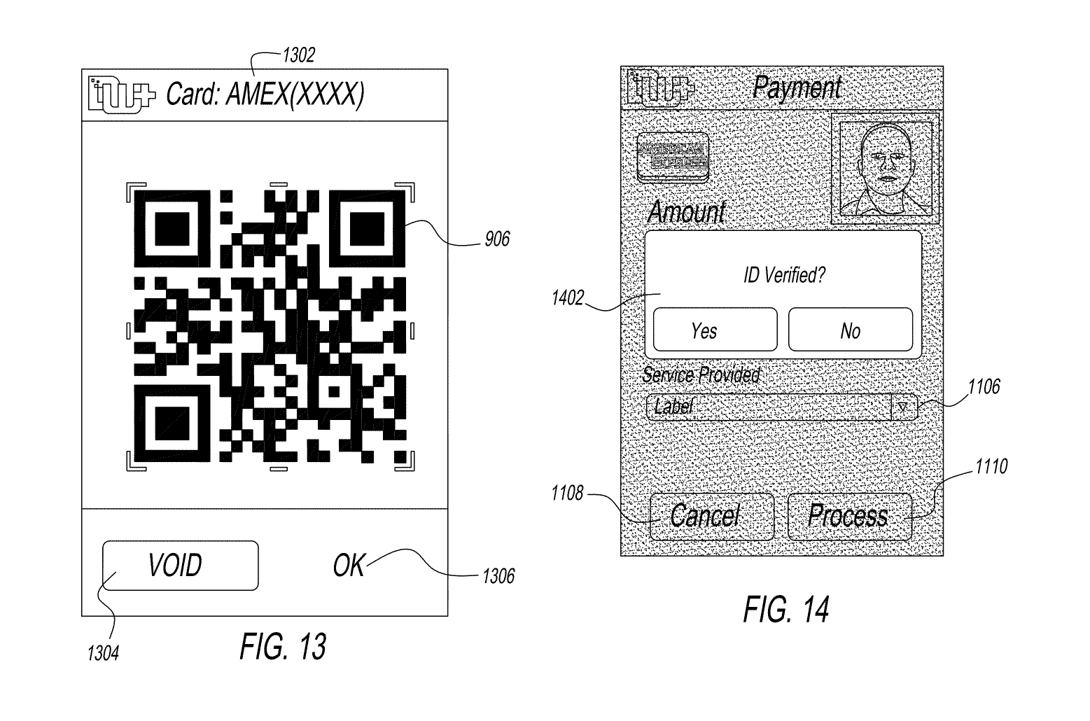

FIG. 7 is a screenshot of a digital wallet app payment selection and initiation screen, according to an exemplary embodiment of the present invention. From this screen a payer can select a payment method, here the only option is a payment account 702 associated with the app, which for example the payer may load from a bank account or credit card. On this screen, a tip bar 704 allows a payer to automatically add a percentage tip to a bill for which payment is being made, for use with restaurant or similar transactions. In other embodiments tailored for different types of payment transactions, other such options may be available. Selecting Make Payment button 706 after selecting a payment method generates the payment code as shown in FIG. 13.

FIG. 8 is a screenshot of a digital wallet app payment selection and initiation screen, according to an exemplary embodiment of the present invention. This screen is similar to FIG. 7, except that multiple payment methods 802 have been pre-registered with the app by the payer, in this case various payer credit cards.

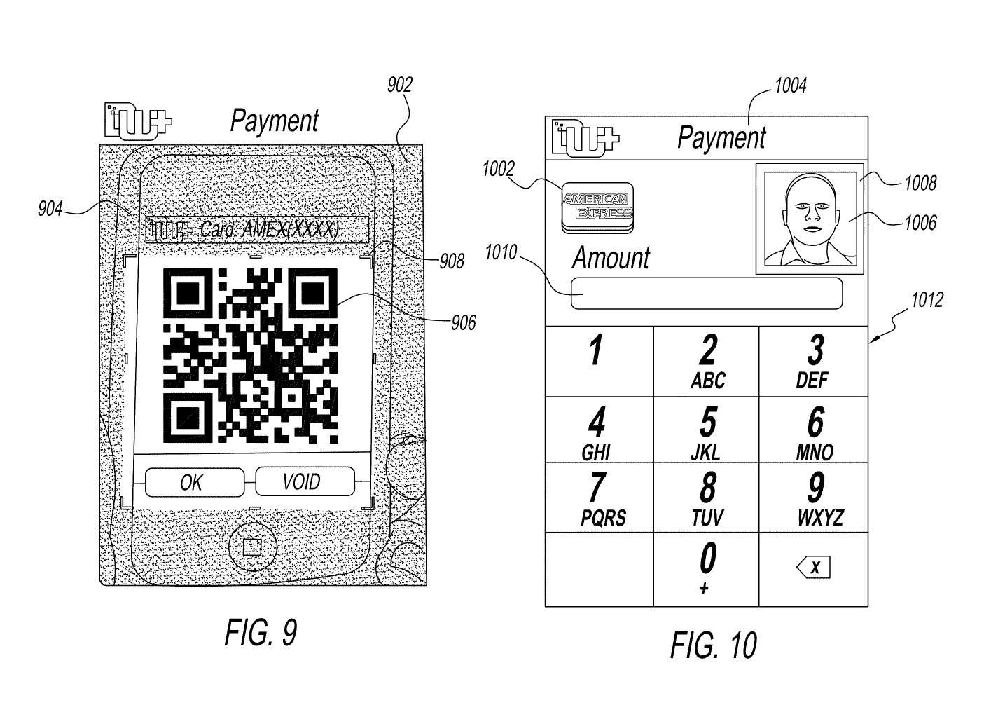

FIG. 9 is a screenshot of a digital wallet app recipient payment code scanner screen, according to an exemplary embodiment of the present invention. This screen shows the view 902 through a camera connected to a recipient device, here the camera is trained on a payer's smart phone 904 displaying a payment code 906 and target 908. Target 908 defines the area in which the app will look for a QR code 906. The recipient maneuvers the recipient's scanner device so the target 908 encompasses the code 906. Once the code 906 is identified, a picture may automatically be taken by the camera.

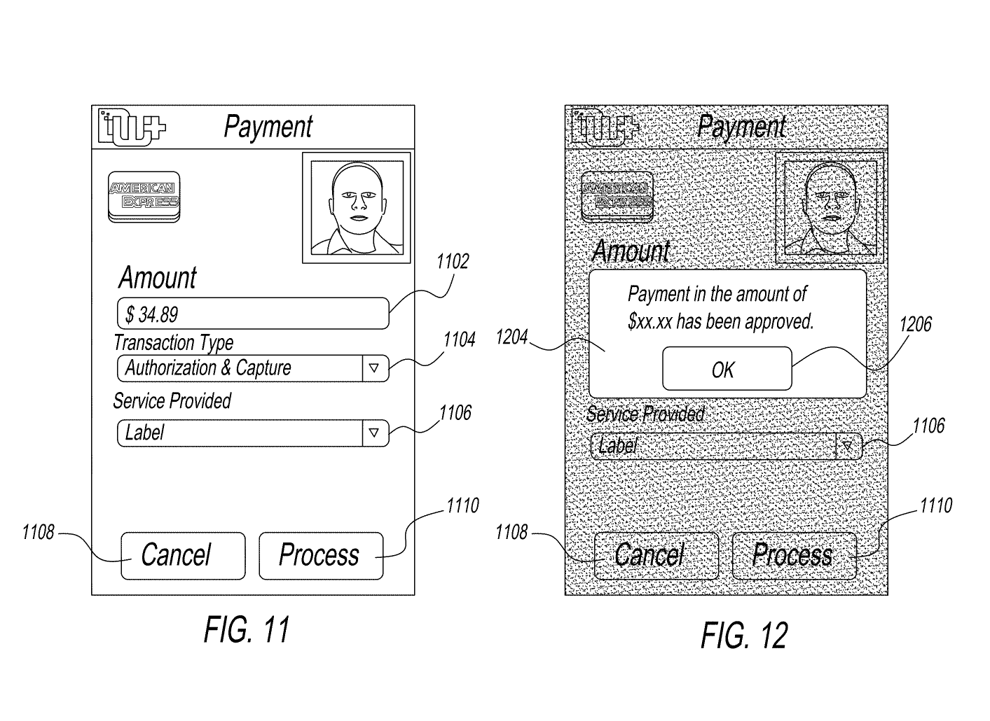

FIG. 10 is a screenshot of a digital wallet app recipient payment amount entry screen, according to an exemplary embodiment of the present invention. This screen may appear on the recipient's computing device after successfully scanning a payment code, showing a payment method 1002, the type of transaction (a payment) 1004 (see FIG. 11), a picture of the payer 1006, a verification border 1008 that may turn green if the payer has been verified or red if the payer has not been verified, a payment amount field 1010 and a standard number pad 1012 for entering a payment amount. The payment method 1002 and payer picture 1006 may be obtained from a system server after a code is scanned by the recipient and verified at the system server, but before sending a request to authorize the transaction. The payer picture may be uploaded by the payer on registration or after, or the picture from an ID document such as a driver's license or passport can be used, if the user transmits that information to the system server for registration or later. The picture 1006 can be used to help the recipient verify the payer's identity. In the illustrated embodiment, verification border 1008 turns red whenever a new picture is selected for presentation by the payer. Once the payer engages in a transaction using the new picture and a recipient verifies the picture, the verification border 1008 turns green to indicate the picture has been verified.

FIG. 11 is a screenshot of a digital wallet app recipient payment amount entry screen, according to an exemplary embodiment of the present invention. This screen may be reached after entering the payment amount in FIG. 10, causing the number pad 1012 covering the buttons/fields 1104, 1106, 1108, 11110 to withdraw, and contains fields showing the payment amount 1102, type of transaction 1104, and product/service provided in the transaction 1106. Cancel button 1108 cancels the transaction and process button 1110 processes the transaction according to the selected settings.

FIG. 12 is a screenshot of a digital wallet app recipient payment approval screen, according to an exemplary embodiment of the present invention. It may be arrived at after selecting the Process button 1110 in the screen of FIG. 11. A message 1204 indicates that the payment has been approved. OK button 1206 clears the message 1204, and the receiver may be sent back to FIG. 9 awaiting the next transaction.

FIG. 13 is a screenshot of a digital wallet app payment code display screen, according to an exemplary embodiment of the present invention. This screen is presented on a payer's smartphone after the Make Payment button 706 is selected and displays payment code 906 and payment method 1302. Selecting the Void button 1304 voids the transaction and selecting the OK button 1306 stops displaying the code without voiding the transaction, such as after the code has already been scanned by the recipient.

FIG. 14 is a screenshot of a digital wallet app recipient ID verification screen, according to an exemplary embodiment of the present invention. In this screen, after payment approval, ID verification is requested 1402. After ID verification, the transaction can be submitted for authorization with Authorize button 1404.

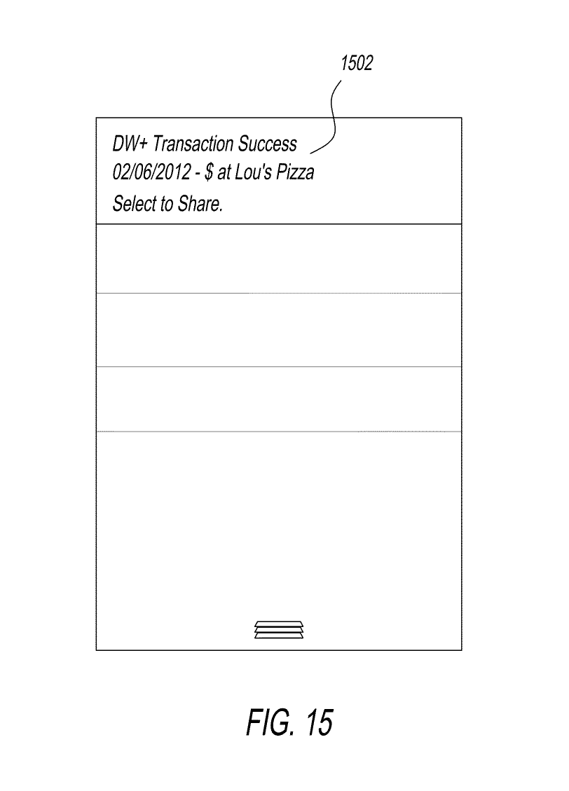

FIG. 15 is a screenshot of a digital wallet app transaction confirmation screen, according to an exemplary embodiment of the present invention. Here, a transaction confirmation message 1502 is displayed to a payer or recipient with transaction summary information.

In one example of a digital wallet transaction, a customer selects items to purchase from a grocery store and takes them to checkout. There, the checkout clerk scans the items and displays the total amount due to the customer. The customer selects a payment app, selects a payment method, and transmits this information to a payment system server, which generates a unique, time-limited code and transmits the unique code to the customer's smart phone app. The customer's smart phone app generates a barcode from the unique code and displays it on the customer's smart phone. The checkout clerk selects the payment system on the checkout terminal and scans the barcode on the customer's smart phone with a barcode scanner connected to a checkout terminal, which translates the barcode into the unique code, which is transmitted along with the total amount due over the Internet to a payment system server. The payment system server uses the unique code to look up the customer and the customer's selected payment method. If the payment method requires third-party authorization, such as a credit card, the payment system server sends the transaction information to the third-party authorization network for authorization and receives the authorization decision from that network, which it then forwards to the grocery store checkout terminal. The checkout terminal accepts the authorization, obtains a signature from the customer if necessary, and prints a receipt for the customer and the customer's app displays a transaction completion summary and confirmation message.

In another example of a digital wallet transaction, a customer selects items to purchase from an online grocery store website, adds them to his cart, and goes to a checkout page. There, the total amount due is calculated and displayed on the checkout page. The customer indicates an intention to pay with a digital payment system. The website server then transmits the amount due to a payment system server, which generates a unique, one-time code associated with the grocery store and amount due and transmits it to the website server, which generates a QR code from the unique code and displays it to the customer on the checkout page. The customer selects a payment app, selects a credit card as the payment method, and takes a picture of the QR code on the customer's desktop monitor with the customer's smart phone. The app then translates the QR code into the unique code, which is transmitted along with the selected payment method over the Internet to the payment system server. The payment system server uses the unique code to look up the grocery store and amount due and looks up the customer's selected payment method. The payment system server transmits selected payment method information directly to the website server, which sends the payment method information and amount due to a credit card authorization network for authorization and receives the authorization decision from that network. The website server displays a receipt for the customer and the customer's app displays a transaction completion summary and confirmation message.

In another example of a digital wallet transaction, a customer selects items to purchase from an online grocery store website, adds them to his cart, and goes to a checkout page. There, the total amount due is calculated and displayed on the checkout page. The customer selects a payment app on the customer's smart phone, selects a payment method, and transmits this information to a payment system server, which generates a unique, time-limited code and transmits the unique code to the customer's smart phone app. The customer's smart phone app generates a QR code from the unique code and displays it on the customer's smart phone. The customer indicates an intention to pay with a digital payment system. The website server instructs the customer's desktop computer to take a picture of the QR code displayed on the customer's smart phone with a web camera connected to the customer's desktop computer and to transmit the picture to the website server. Website server translates the QR code into the unique code, which is transmitted along with the total amount due over the Internet to a payment system server. The payment system server uses the unique code to look up the customer and the customer's selected payment method. If the payment method requires third-party authorization, such as a credit card, the payment system server sends the transaction information to the third-party authorization network for authorization and receives the authorization decision from that network, which it then forwards to the website server. The website server accepts the authorization and displays a receipt for the customer and the customer's app displays a transaction completion summary and confirmation message.

In various embodiments similar to the one above, the app may be installed on the customer's desktop computer or smart phone and the QR code may be displayed on the customer's desktop computer screen or smart phone screen, regardless of where the app is installed. The smart phone may take a picture of the desktop display or vice versa, depending on where the QR code is displayed. For single device implementations, instead of taking a picture with a camera, the customer may take a screenshot of the customer's screen using the app or pre-existing software and transmit the screenshot instead of a picture. In some embodiments the picture or screenshot may be cropped manually or automatically before transmission to contain only the image of the QR code. In other embodiments, the QR code may not be displayed on the customer's device at all, but rather may be sent by the payment system server to the customer's computing device as an image file, which is uploaded to the website server by the customer via the website checkout page or by FTP, email, or any other method. Similar variations may be envisioned by one of skill in the art.

In another example of a digital wallet transaction, a customer selects books to checkout from a library and takes them to checkout. There, the checkout clerk scans the items and waits for the customer's library card. The customer selects a transaction app, selects the customer's library card from a list of possible transaction methods, and transmits this information to a transaction system server, which generates a unique code and transmits the unique code to the customer's smart phone app. The customer's smart phone app generates a barcode from the unique code and displays it on the customer's smart phone. The checkout clerk scans the barcode on the customer's smart phone with a barcode scanner connected to a checkout terminal, which translates the barcode into the unique code, which is transmitted to the transaction system server. The transaction system server uses the unique code to look up the customer and the customer's selected transaction method, and finds pre-registered information associated with the customer's library card, in this case magnetic stripe data from the customer's physical library card. The payment system server sends the magnetic stripe data to the grocery store checkout terminal, which processes the data as if it were received by swiping the customer's physical library card. The customer's app displays a transaction completion summary and confirmation message.

The application of the present invention may be a software application, written in one or more computer code(s) and disposed on computer readable media. The application may include computer code sequences adapted to perform the functions as described in the above description and accompanying drawings. The application may be a smart device application, for example, a smart phone application, and/or a web application, web plugin and/or native personal computer application.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, Python, Ruby on Rails, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A system for conducting secure electronic transactions, the system comprising:
one or more physical processors;
storage media storing machine-readable instructions that cause the one or more physical processors:
to receive a transaction request comprising first transaction information from a first user;
to store at least some of the first transaction information;
to generate a system-generated code and associate the system-generated code with at least one of the stored transaction information and pre-existing first user information;
to transmit the system-generated code to the first user;
to receive a user-sent code from a second user with second transaction information;
to validate the user-sent code and determine any stored transaction information and pre-existing first user information associated with the user-sent code;
to cause an authorization decision to be rendered for a transaction associated with the stored transaction information and pre-existing first user information associated with the user-sent code and second transaction information; and
to transmit the authorization decision to at least one of the first user and the second user;
wherein the system-generated code does not contain any transaction method information and is at least one of time-limited, one-time use, and limited to use with a single transaction partner.

2. The system of claim 1, wherein the system-generated code expires after fifteen minutes or less.

3. The system of claim 1, wherein the system-generated code is a one-time use code.

4. The system of claim 1, wherein the machine-readable instructions further cause the one or more physical processors to create a transaction-level code associated with the system-generated code that is at least one of audible and visual.

5. The system of claim 4, wherein the transaction-level code is a barcode or QR code.

6. The system of claim 1, wherein causing an authorization decision to be rendered for the transaction comprises submitting the transaction to an authorization network for a payment method associated with the transaction, wherein the machine-readable instructions further cause the one or more physical processors to receive the authorization decision from the authorization network.

7. The system of claim 1, further comprising a payment account associated with the first user or the second user, wherein causing an authorization decision to be rendered for the transaction comprises rendering the authorization decision based on information associated with the transaction and with the payment account.

8. The system of claim 1, wherein the first user is a payer and the second user is a recipient.

9. The system of claim 8, wherein the first transaction information from the payer comprises identification of the payer and a desired transaction method and the pre-existing first user information comprises details associated with the desired transaction method, and wherein the second transaction information comprises identification of the recipient.

10. The system of claim 9, wherein the desired transaction method comprises a desired payment method and the details associated with the desired transaction method comprise identifying information for the desired payment method.

11. The system of claim 1, wherein the first user is a recipient and the second user is a payer.

12. The system of claim 11, wherein the first transaction information from the recipient comprises identification of the recipient, wherein the second transaction information comprises identification of the payer and a desired transaction method, and wherein the machine-readable instructions further cause the one or more physical processors to use the identification of the payer to retrieve pre-existing payer information comprising details associated with the desired transaction method.

13. The system of claim 12, wherein the desired transaction method comprises a desired payment method and the details associated with the desired transaction method comprise identifying information for the desired payment method.

14. The system of claim 4, wherein the user-sent code is the transaction-level code, wherein validating the user-sent code comprises translating the user-sent code to the system-generated code.

15. The system of claim 1, wherein the machine-readable instructions further cause the one or more physical processors to determine whether the first user is located proximate the second user, and to require additional authentication steps if the first and second users are determined not to be proximate one another.

16. The system of claim 1, wherein the machine-readable instructions further cause the one or more physical processors to display a graphic interface to the first user for inputting the first transaction information, and to create, and at least one of display and broadcast, a transaction-level code associated with the system-generated code that is at least one of audible and visual.

17. The system of claim 16, wherein the machine-readable instructions further cause the one or more physical processors to display a graphic interface for receiving the second transaction information from the second user, to at least one of scan and image the transaction-level code and translate it to the system-generated code, and responsive to a successful authorization decision, to display a graphic interface for signing and to receive the first or second user's signature.

18. The system of claim 1, wherein the machine-readable instructions further cause the one or more physical processors to display a graphic interface for receiving the second transaction information from the second user, at least one of scan and image a transaction-level code and translate it to the user-sent code, and responsive to a successful authorization decision, to display a graphic interface for signing and to receive the first or second user's signature.

19. A system for conducting secure electronic transactions, the system comprising:
one or more processors configured to execute computer program modules, the computer program modules comprising:
a code generation module configured to generate a unique code associated with a payer and payer's selected transaction method, responsive to a request from the payer computing platform to conduct a transaction using that transaction method;
a code validation module configured to validate a unique code received from a recipient by attempting to match it with a stored unique code associated with a payer and payer's selected transaction method;
an interface module configured to communicate with at least one of the payer, the recipient, and a transaction authorization network;
a logging module configured to log in electronic storage at least one of information received from the payer, information received from the recipient, information received from the transaction authorization network, information generated by the code generation module, information generated by the code validation module, and information generated by the interface module;
wherein the unique code associated with the payer does not contain any transaction method information and is at least one of time-limited, one-time use, and limited to use with a single transaction partner.

20. The system of claim 19, further comprising a network authorization module configured to submit electronic transaction information associated with a unique code, together with transaction method information, to an appropriate transaction authorization network for transaction authorization and to receive and process an approval or denial decision from the transaction authorization network server and relay that decision to the recipient.

21. A system for conducting secure electronic transactions, the system comprising:
one or more physical processors;
storage media storing machine-readable instructions that cause the one or more physical processors:
to receive a transaction request comprising a selected transaction method from a first user;
to generate a system-generated code and associate the system-generated code with the first user;
to transmit the system-generated code to the first user;
to receive a user-sent code from a second user;
to determine that the user-sent code is associated with the first user; and
to cause an authorization decision to be rendered for a transaction associated with the first user, the selected transaction method, and identification information associated with the selected transaction method;
wherein the system-generated code does not contain any transaction method information and is at least one of time-limited, one-time use, and limited to use with a single transaction partner.

22. A secure electronic transaction method, comprising:
generating a unique code associated with a payer and payer's selected transaction method, responsive to a request from the payer computing platform to conduct a transaction using that transaction method;
validating a unique code received from a recipient by attempting to match it with a stored unique code associated with a payer and payer's selected transaction method;
communicating with at least one of the payer, the recipient, and a transaction authorization network;
logging in electronic storage at least one of information received from the payer, information received from the recipient, information received from the transaction authorization network, information generated by generating the unique code associated with the payer, information generated by validating the unique code received from the recipient, and information generated by communicating;
wherein the unique code associated with the payer does not contain any transaction method information and is at least one of time-limited, one-time use, and limited to use with a single transaction partner.

23. The method of claim 22, further comprising submitting electronic transaction information associated with a unique code, together with transaction method information, to an appropriate transaction authorization network for transaction authorization and receiving an approval or denial decision from the transaction authorization network server and relaying that decision to the recipient.
